(19) United States
(12) Patent Application Publication
(10) Pub. No.: US 2021/0127731 A1
(43) Pub. Date: May 6, 2021

(54) System and Method of Manufacturing Whole-Meat, Spiral-Shaped Jerky Curls

(71) Applicant: James Lesslie, Las Vegas, NV (US)

(72) Inventor: James Lesslie, Las Vegas, NV (US)

(21) Appl. No.: 17/089,718

(22) Filed: Nov. 4, 2020

Related U.S. Application Data
(60) Provisional application No. 62/930,470, filed on Nov. 4, 2019.

(51) Int. Cl. A23P 30/10; A23L 13/40

(52) U.S. Cl. CPC A23P 30/10; A23V 2002/00; A23L 13/428

(57) ABSTRACT

A system and method of manufacturing whole-meat, spiral shaped jerky curls produce a stylized spiral-shaped meat snack. The system includes a plurality of meat strips, an emulsion of seasoning, a refrigerator, a plurality of perforated tubes, and a drying oven. The method begins by cooling each meat strip within the emulsion of seasoning for a first specified period of time at a first specified temperature range with the refrigerator. Each meat strip is then wrapped around a corresponding tube from a plurality of perforated tubes. Each meat strip and corresponding tube is then racked into the drying oven. Each meat strip is heated for s second specified period of time at a second specified temperature range. Each meat strip in spiral-shaped curl is then removed from the corresponding tube and each meat strip is cooled in the spiral-shaped curl for a third specified period of time at an ambient temperature.

The current application claims a priority to the U.S. provisional patent application Ser. No. 62/930,470 filed on Nov. 4, 2019.

The current application also claims a priority to a U.S. design application Ser. No. 29/723,611 filed on Feb. 7, 2020.

### FIELD OF THE INVENTION

The present invention relates generally to jerky-curls. More specifically, the present invention is a system and method of manufacturing whole-meat, spiral-shaped jerky curls with a distinct spongy, chewier texture and stylized spiral shape with a unique flavor and taste in the least amount of time without complex machinery.

### BACKGROUND OF THE INVENTION

Dried or dehydrated meat products referred in the art as jerky products are a popular snack food and gift item enjoyed by consumers. The popularity of jerky products among the consumers has increased over time. Jerky products are now shipped overseas and marketed in foreign countries including Canada, Europe, Japan, etc.

There are multiple methods for producing jerky products. In one conventional method, jerky products are prepared from ground meat. In this method, meat is ground to a desired consistency and blended with selected ingredients, for example, preservatives, curing agents, binding agents, and a combination of flavoring agents to combine the ground meat and enhance the taste of a jerky product. The ground and blended mixture is then suitably cured for a predetermined amount of time and solidified by freezing for producing a loaf of meat that can be cut into slices. The slices of meat are dried or dehydrated in a drying chamber or a dehydrator, and in some cases, dehydration is performed by heating in oil or fat in a vacuum to produce edible jerky products. This method is time consuming as it requires a freezing step to solidify the meat dough into a loaf of meat.

In another conventional method, a rotary molder is used to produce jerky products. In this method, extruded meat dough is produced by blending ground meat components with selected preservatives, curing agents, and flavoring agents. The extruded meat dough is fed to the rotary molder to produce meat pieces in a desired shape. The meat pieces are dried or dehydrated to produce edible jerky products. Slicing the extruded meat dough typically requires the extruded meat dough to be in a solid state, which may be achieved by chilling or freezing the extruded meat dough. Although this method facilitates accurate slicing of the extruded meat dough, the texture of the jerky product may be undesirable as the jerky product crumbles easily or results in products that look machine-made.

Hence, there is long felt need for a method for preparing whole, single strips of jerky having a distinct spongy, chewier texture and stylized shape with a unique flavor and taste in the least amount of time without complex machinery.

### BRIEF DESCRIPTION OF THE DRAWINGS

FIG. 1 is a schematic view illustrating the system of the present invention.

FIG. 2 is a block diagram illustrating the proportions for an emulsion of seasoning.

FIG. 3 is a flowchart illustrating the overall process for the method of the present invention.

FIG. 4 is a flowchart illustrating the subprocess of marinating a slab of meat prior to slicing the slab of meat into a plurality of meat strips.

FIG. 5 is a flowchart illustrating the subprocess of storing the slab of meat prior to marinating the slab of meat.

FIG. 6 is a flowchart illustrating the subprocess of marinating each meat strip after slicing the slab of meat into a plurality of meat strips.

FIG. 7 is a flowchart illustrating the subprocess of storing the slab of meat prior to slicing the slab of meat.

FIG. 8 is a flowchart illustrating the subprocess of heating and stirring each ingredient in the emulsion of seasoning together.

FIG. 9 is a flowchart illustrating the subprocess of heating each meat strip in increments.

FIG. 10 is a flowchart illustrating the subprocess of securely wrapping each meat strip into the drying oven and removing each meat strip in the spiral-shaped curl from the drying oven with a plurality of saddles and a roll-up rack.

FIG. 11 is a flowchart illustrating the subprocess of distributing the plurality of meat strips in the spiral-shaped curl into a plurality of bins.

### DETAIL DESCRIPTIONS OF THE INVENTION

All illustrations of the drawings are for the purpose of describing selected versions of the present invention and are not intended to limit the scope of the present invention.

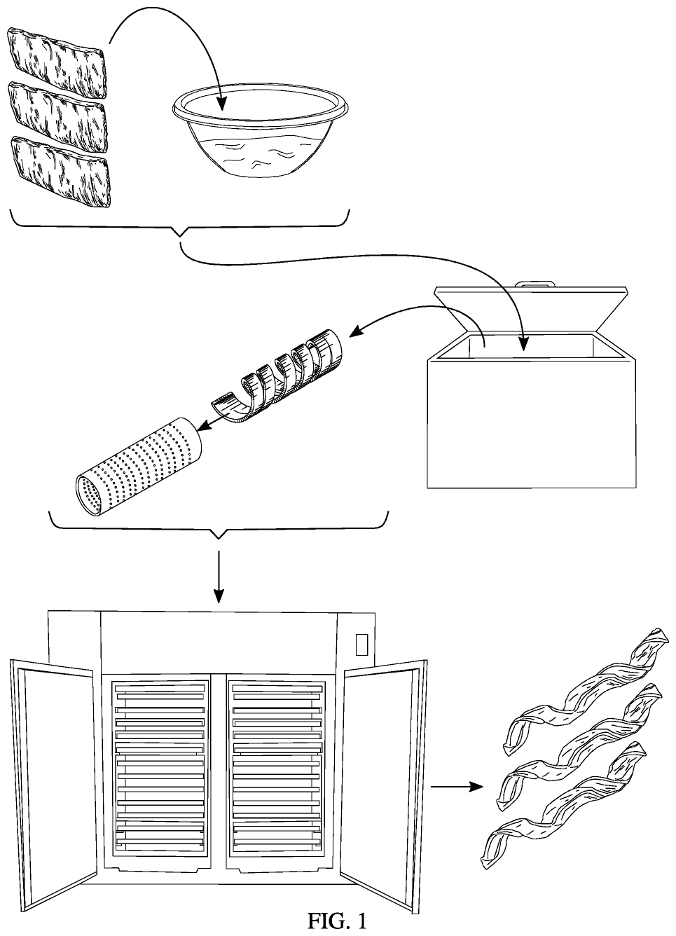

The present invention is a system and method of manufacturing whole-meat, spiral shaped jerky curls. The present invention produces whole jerky of a distinct spongy and chewier texture with a spiral shape. Thus, in order for the whole jerky to obtain and maintain a spiral shape, the physical system of the present invention is provided with a plurality of meat strips and an emulsion of seasoning (Step A), seen in FIG. 1. The plurality of meat strips is preferably beef. However, the plurality of meat strips can alternatively be pork, lamb, goat, turkey, chicken, and so on. The emulsion of seasoning serves as the marinade for the whole jerky which defines the taste of the whole jerky. In order to process the plurality of meat strips and incorporate the emulsion of seasoning into the plurality of meat strips, the physical system of the present invention is further provided with a refrigerator, a plurality of perforated tubes, and a drying oven (Step B), also seen in FIG. 1. The refrigerator is used to cool the plurality of meat strips, until the plurality of meat strips is ready to be cooked during the method of the present invention. The plurality of perforated tubes is used to wrap and dry each meat strip into a spiral-shaped curl. Each perforated tube is preferably made of electropolished stainless steel. Moreover, an outer diameter of each perforated tube is preferably 0.629 inches, and a perforation pattern of each perforated tube is preferably 5/32-inch hole by 3/16-inch staggered centers. The drying oven is used to cook the plurality of meat strips marinated with the emulsion of seasoning. The drying oven is preferably an AMISY electric drying oven. However, the drying oven can be alternatively by any other type of electric drying oven.

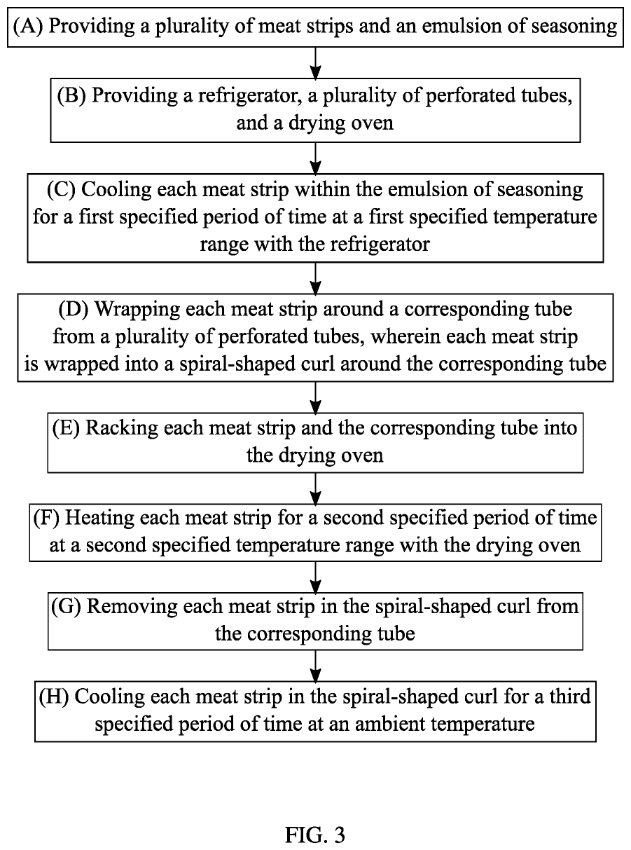

The overall process for the method of the present invention includes the following steps that are implemented with the plurality of meat strips, the emulsion of seasoning, the refrigerator, the plurality of perforated tubes, and the drying oven. As seen in FIG. 3, the overall process begins by cooling each meat strip within the emulsion of seasoning for a first specified period of time at a first specified temperature range with the refrigerator (Step C), which allows the plurality of meat strips to be sufficiently marinated within the emulsion of seasoning. The flavor of the plurality of meat strips is enhanced as the first specified period of time is preferably 24 hours, and the first specified temperature range is preferably between 36 degrees Fahrenheit and 40 degrees Fahrenheit. Upon the completion of marination, each meat strip is then wrapped around a corresponding tube from a plurality of perforated tubes, wherein each meat strip is wrapped into a spiral-shaped curl around the corresponding tube (Step D). Each meat strip therefore cooks in a spiral-shaped curl. Then, each meat strip and the corresponding tube is racked into the drying oven (Step E) and is heated for a second specified period of time at a second specified temperature with the drying oven (Step F). The spiral-shaped curl is defined and maintained as each meat strip is cooked during the second specified period of time. The second specified period of time is preferably 6 hours, and the second specified temperature range is preferably between 135 degrees Fahrenheit and 180 degrees Fahrenheit. Each meat strip in the spiral-shaped curl is removed from the corresponding tube (Step G). The plurality of meat strips is ready to be eaten or packaged after each meat strip in the spiral-shaped curl is cooled for a third specified period of time at an ambient temperature (Step H). The third specified period of time is preferably 24 hours.

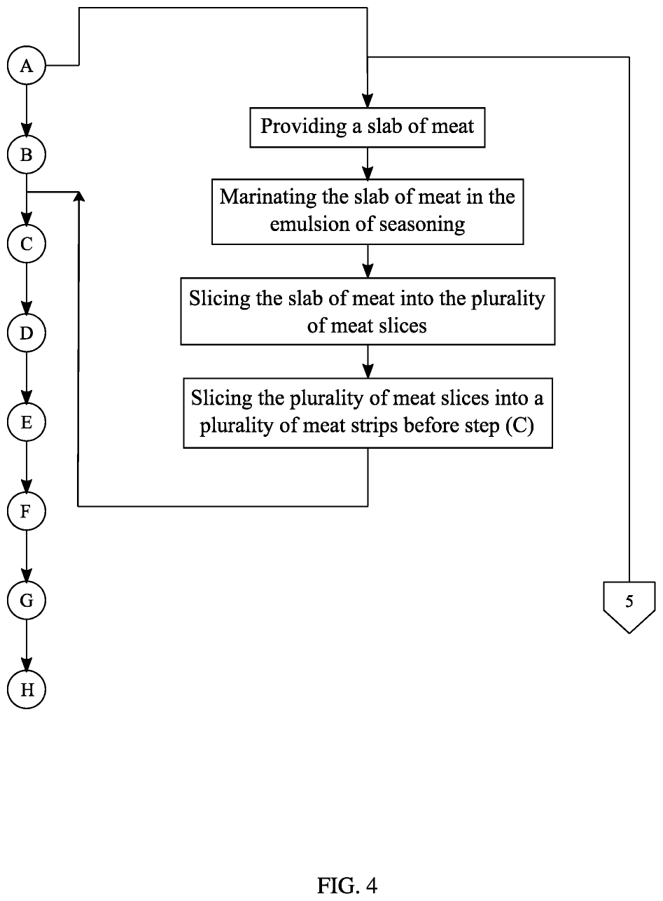

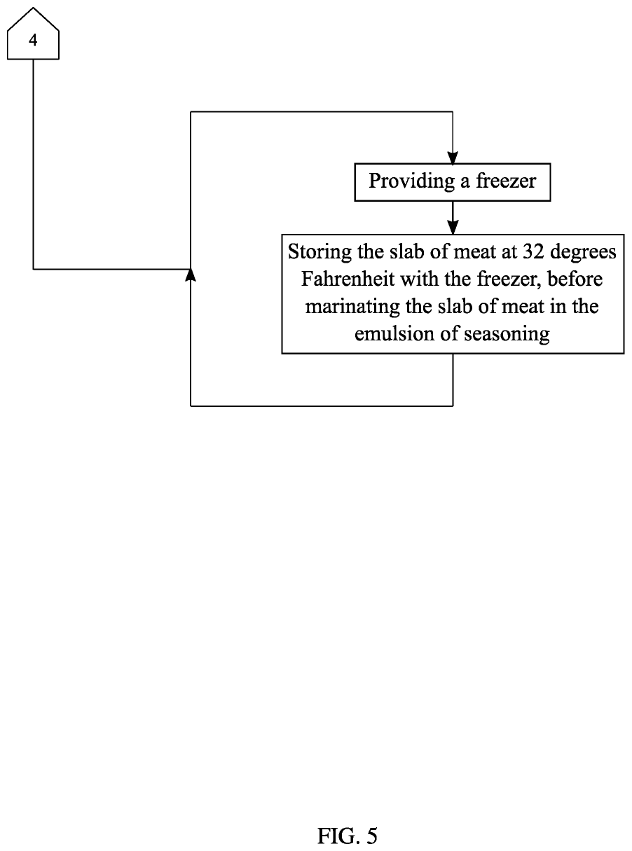

The present invention has two alternative subprocesses for meat marination, both which are provided with a slab of meat. In the first subprocess of meat marination, seen in FIG. 4, the slab of meat starts off being marinated in the emulsion of seasoning. The slab of meat is sliced into the plurality of meat slices, and the plurality of meat slices is then sliced into a plurality of meat strips for smaller and thinner portions of meat before Step C. A width of each meat slice is preferably 1 inch, and a thickness of each meat strip is preferably 0.125 inches. Prior to marinating the slab of meat, a freezer is provided to store the slab of meat for an extended period of time, seen in FIG. 5. Thus, the slab of meat is preferably stored at 32 degrees Fahrenheit within the freezer, before marinating the slab of meat in the emulsion of seasoning.

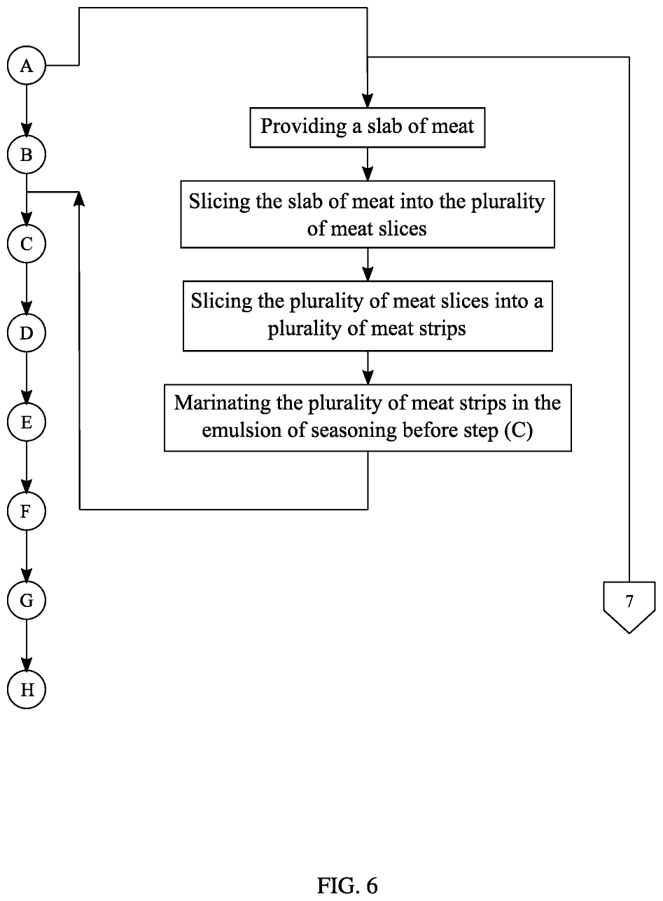

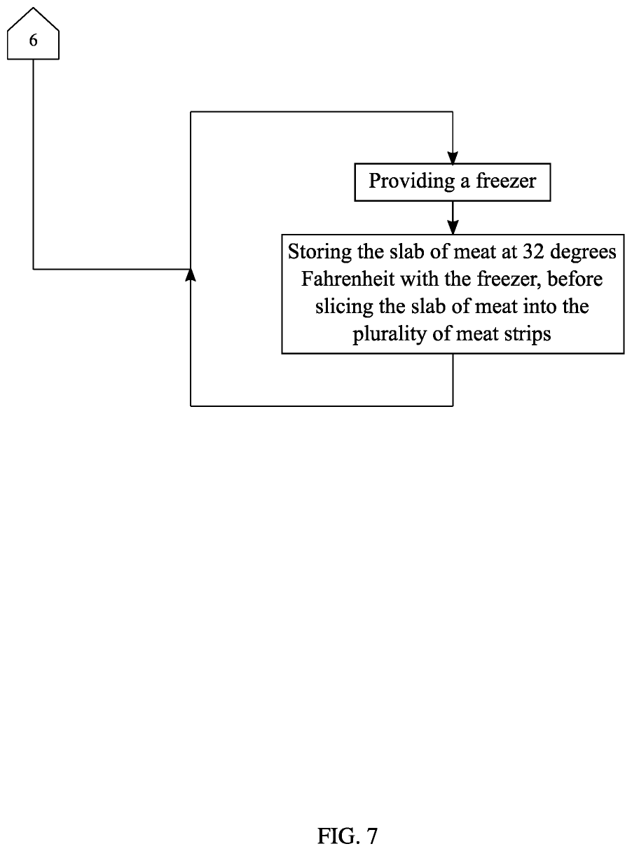

In the second embodiment of meat marination, seen in FIG. 6, the slab of meat starts off by being sliced into the plurality of meat slices, and the plurality of meat slices is then sliced into a plurality of meat strips. Each of the plurality of meat strips is sealed with flavor instead of the slab of meat as the plurality of meat strips is marinated in the emulsion of seasoning before Step C. More specifically, each meat strip is positioned in a container with the emulsion of seasoning one at a time and stirred with the emulsion of seasoning, until each meat strip is evenly coated. Similarly, a width of each meat slice is preferably 1 inch, and a thickness of each meat strip is preferably 0.125 inches. Prior to slicing the slab of meat into the plurality of meat strips, a freezer is again provided to store the slab of meat for an extended period of time, seen in FIG. 7. Likewise, the slab of meat is preferably stored at 32 degrees Fahrenheit within the freezer, before slicing the slab of meat into the plurality of meat strips.

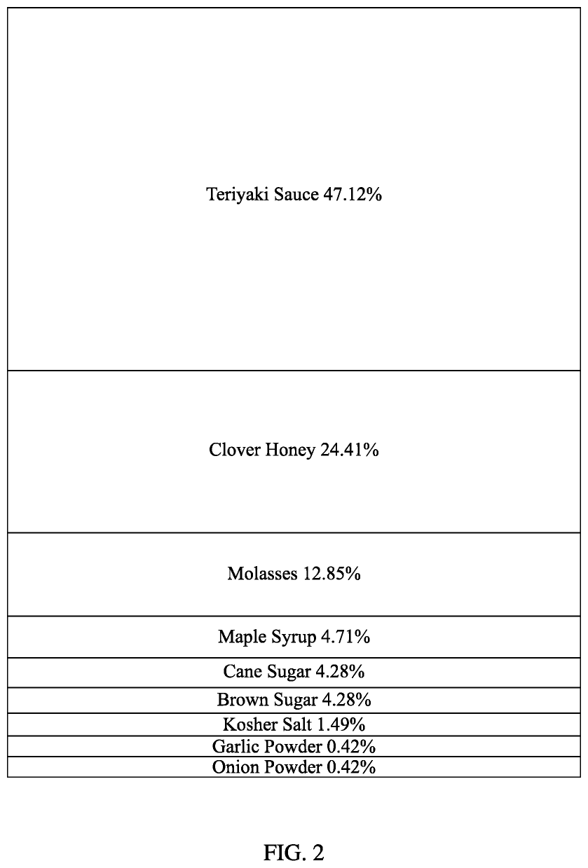

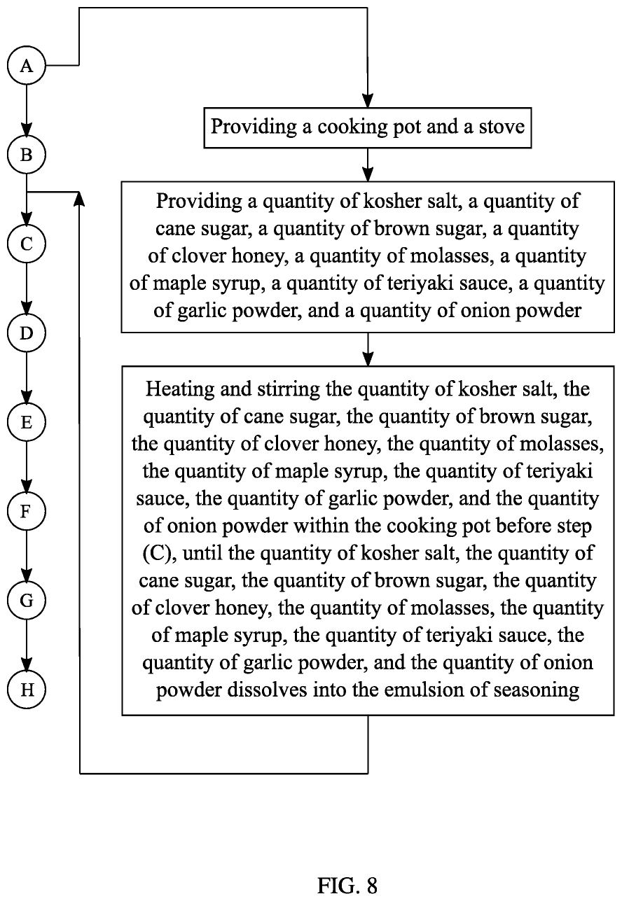

A subprocess for preparing the emulsion of seasoning requires a cooking pot and a stove, seen in FIG. 8. A quantity of kosher salt, a quantity of cane sugar, a quantity of brown sugar, a quantity of clover honey, a quantity of molasses, a quantity of maple syrup, a quantity of teriyaki sauce, a quantity of garlic powder, and a quantity of onion powder is provided as ingredients for the emulsion of seasoning, seen in FIG. 2 and FIG. 8. The quantity of kosher salt enhances the flavor of the emulsion of seasoning, and, in the preferred embodiment, the quantity of kosher salt is approximately 1.49% by weight (wt.) of the emulsion of seasoning. The quantity of cane sugar, the quantity of brown sugar, the quantity of clover honey, the quantity of molasses, and the quantity of maple syrup sweetens the emulsion of seasoning. In addition, the quantity of clover honey not only imparts a flavor for the plurality of meat strips but facilitates the removal of each meat strip in spiral-shaped curl from the corresponding tube. In the preferred embodiment, the quantity of cane sugar is approximately 4.28% wt. of the emulsion of seasoning, the quantity of brown sugar is approximately 4.28% wt. of the emulsion of seasoning, the quantity of clover honey is approximately 24.41% wt. of the emulsion of seasoning, the quantity of molasses is approximately 12.85% wt. of the emulsion of seasoning, and the quantity of maple syrup is approximately 4.71% wt. of the emulsion of seasoning. The quantity of teriyaki sauce defines the overall flavor of the emulsion of seasoning as teriyaki flavored jerky, and, in the preferred embodiment, the quantity of teriyaki sauce is approximately 47.12% wt. of the emulsion of seasoning. The quantity of garlic powder and the quantity of onion powder compliments the teriyaki flavor. In the preferred embodiment, the quantity of garlic powder is approximately 0.42% wt. of the emulsion of seasoning, and the quantity of onion powder is approximately 0.42% wt. of the emulsion of seasoning. The quantity of kosher salt, the quantity of cane sugar, the quantity of brown sugar, the quantity of clover honey, the quantity of molasses, the quantity of maple syrup, the quantity of teriyaki sauce, the quantity of garlic powder, and the quantity of onion powder is heated and stirred within the cooking pot before Step C, until the quantity of kosher salt, the quantity of cane sugar, the quantity of brown sugar, the quantity of clover honey, the quantity of molasses, the quantity of maple syrup, the quantity of teriyaki sauce, the quantity of garlic powder, and the quantity of onion powder dissolve into the emulsion of seasoning. The heating and the stirring of the combination of ingredients concentrates and intensifies the flavor or the emulsion of seasoning.

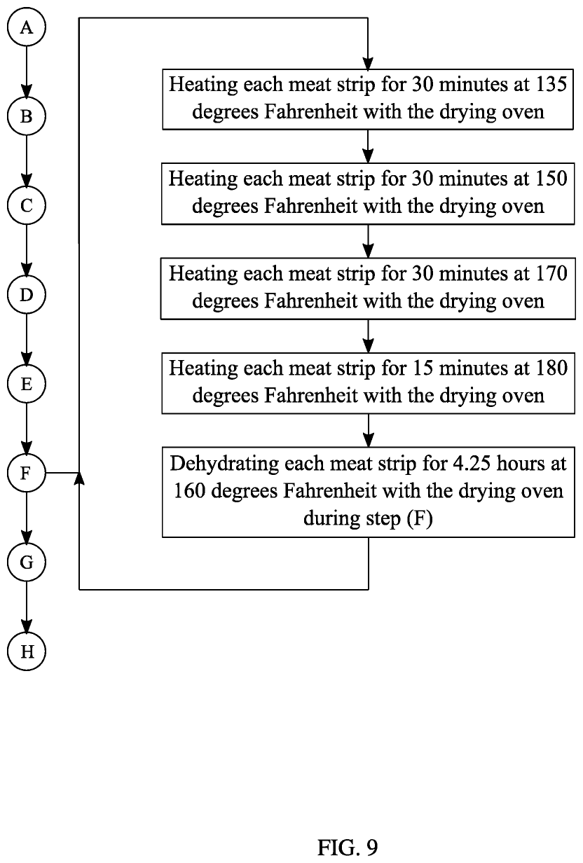

In order to evenly cook each meat strip for a spongy and chewy texture, each meat strip is heated for 30 minutes at 135 degrees Fahrenheit with the drying oven, seen in FIG. 9. Each meat strip is then heated for 30 minutes at 150 degrees Fahrenheit with the drying oven. Each meat strip is then heated for 30 minutes at 170 degrees Fahrenheit with the drying oven. Each meat strip is then heated for 15 minutes at 180 degrees Fahrenheit with the drying oven. Each meat strip is then dehydrated for 4.25 hours at 160 degrees Fahrenheit with the drying oven during Step F. Throughout each increment, the flavor with each meat strip is further sealed.

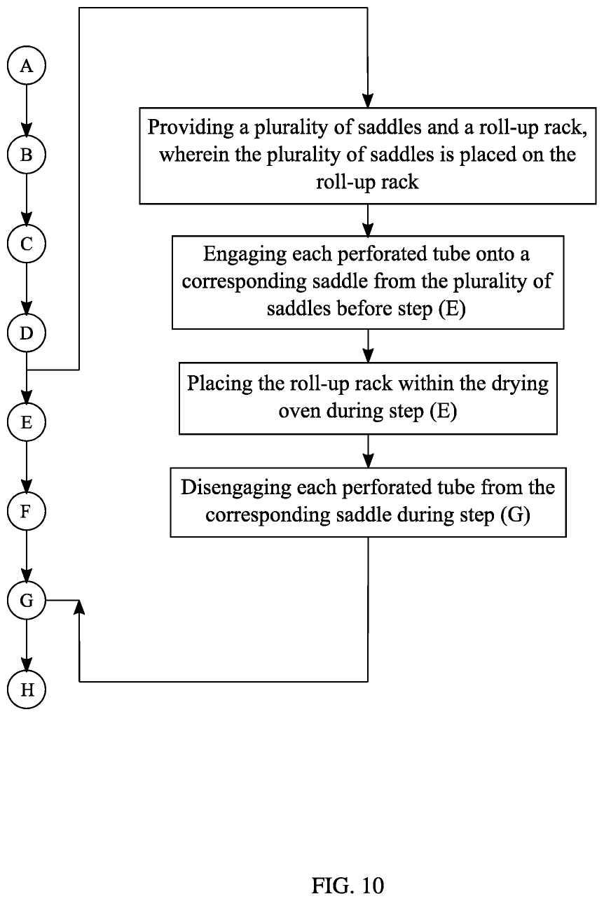

In order to securely heat each meat strip, a plurality of saddles and a roll-up rack are provided within the drying oven, wherein the plurality of saddles is placed on the roll-up rack within the drying oven, seen in FIG. 1 and FIG. 10. Each saddle secures each perforated tube with the meat strip within the drying oven. The roll-up rack organizes and positions the plurality of saddles within the drying oven. The plurality of perforated tubes is preferably spaced one inch apart by the plurality of saddles. In order to evenly cook each meat strip, each perforated tube is engaged onto a corresponding saddle from the plurality of saddles before Step E. The roll-up rack is placed within the drying oven during Step E, stabilizing and offsetting each saddle from one another. Each perforated tube is disengaged from the corresponding saddle during Step G facilitating the removal of each meat strip in spiral-shaped curl from the corresponding tube.

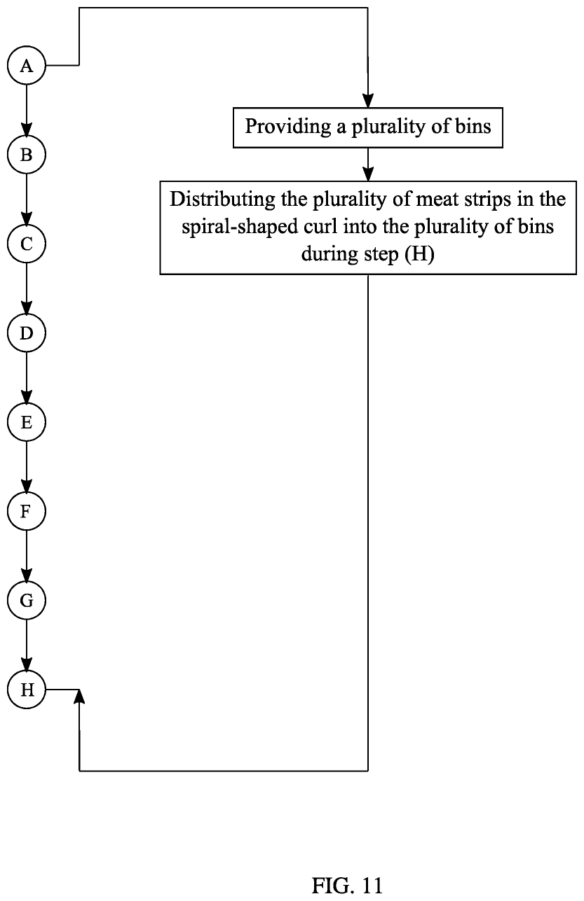

In order to protect the plurality of meat strips in spiral-shaped curls, a plurality of bins is provided, seen in FIG. 11. The plurality of meat strips is thoroughly and evenly cooled as the plurality of meat strips in the spiral-shaped curl is distributed into the plurality of bins during Step H. In some embodiments, the plurality of meat strips in spiral-shaped curls is then prepped for a vacuum-sealed package with a vacuum sealing machine.

Although the invention has been explained in relation to its preferred embodiment, it is to be understood that many other possible modifications and variations can be made without departing from the spirit and scope of the invention as hereinafter claimed.

1. A method of manufacturing whole-meat, spiral-shaped jerky curls, the method comprises the steps of:
(A) providing a plurality of meat strips and an emulsion of seasoning;
(B) providing a refrigerator, a plurality of perforated tubes, and a drying oven;
(C) cooling each meat strip within the emulsion of seasoning for a first specified period of time at a first specified temperature range with the refrigerator;
(D) wrapping each meat strip around a corresponding tube from a plurality of perforated tubes, wherein each meat strip is wrapped into a spiral-shaped curl around the corresponding tube;
(E) racking each meat strip and the corresponding tube into the drying oven;
(F) heating each meat strip for a second specified period of time at a second specified temperature range with the drying oven;
(G) removing each meat strip in the spiral-shaped curl from the corresponding tube; and,
(H) cooling each meat strip in the spiral-shaped curl for a third specified period of time at an ambient temperature.

2. The method of manufacturing whole-meat, spiral-shaped jerky curls, the method as claimed in claim 1 comprises the steps of:
providing a slab of meat;
marinating the slab of meat in the emulsion of seasoning;
slicing the slab of meat into the plurality of meat slices; and,
slicing the plurality of meat slices into a plurality of meat strips before step (C).

3. The method of manufacturing whole-meat, spiral-shaped jerky curls, the method as claimed in claim 2, wherein a width of each meat slice is 1 inch, and wherein a thickness of each meat strip is 0.125 inches.

4. The method of manufacturing whole-meat, spiral-shaped jerky curls, the method as claimed in claim 2 comprises the steps of:
providing a freezer; and,
storing the slab of meat at 32 degrees Fahrenheit with the freezer.

5. The method of manufacturing whole-meat, spiral-shaped jerky curls, the method as claimed in claim 1 comprises the steps of:
providing a slab of meat;
slicing the slab of meat into the plurality of meat slices;
slicing the plurality of meat slices into a plurality of meat strips;
marinating the plurality of meat strips in the emulsion of seasoning before step (C).

6. The method of manufacturing whole-meat, spiral-shaped jerky curls, the method as claimed in claim 5, wherein a width of each meat slice is 1 inch, and wherein a thickness of each meat strip is 0.125 inches.

7. The method of manufacturing whole-meat, spiral-shaped jerky curls, the method as claimed in claim 5 comprises the steps of:
providing a freezer; and,
storing the slab of meat at 32 degrees Fahrenheit with the freezer, before slicing the slab of meat into the plurality of meat strips.

8. The method of manufacturing whole-meat, spiral-shaped jerky curls, the method as claimed in claim 1 comprises the steps of:
providing a cooking pot and a stove;
providing a quantity of kosher salt, a quantity of cane sugar, a quantity of brown sugar, a quantity of clover honey, a quantity of molasses, a quantity of maple syrup, a quantity of teriyaki sauce, a quantity of garlic powder, and a quantity of onion powder; and,
heating and stirring the quantity of kosher salt, the quantity of cane sugar, the quantity of brown sugar, the quantity of clover honey, the quantity of molasses, the quantity of maple syrup, the quantity of teriyaki sauce, the quantity of garlic powder, and the quantity of onion powder within the cooking pot before step (C), until the quantity of kosher salt, the quantity of cane sugar, the quantity of brown sugar, the quantity of clover honey, the quantity of molasses, the quantity of maple syrup, the quantity of teriyaki sauce, the quantity of garlic powder, and the quantity of onion powder dissolves into the emulsion of seasoning.

9. The method of manufacturing whole-meat, spiral-shaped jerky curls, the method as claimed in claim 7, the quantity of kosher salt is approximately 1.49% by weight (wt.) of the emulsion of seasoning, the quantity of cane sugar is approximately 4.28% wt. of the emulsion of seasoning, the quantity of brown sugar is approximately 4.28% wt. of the emulsion of seasoning, the quantity of clover honey is approximately 24.41% wt. of the emulsion of seasoning, the quantity of molasses is approximately 12.85% wt. of the emulsion of seasoning, the quantity of maple syrup is approximately 4.71% wt. of the emulsion of seasoning, the quantity of teriyaki sauce is approximately 47.12% wt. of the emulsion of seasoning, the quantity of garlic powder is approximately 0.42% wt. of the emulsion of seasoning, and the quantity of onion powder is approximately 0.42% wt. of the emulsion of seasoning.

10. The method of manufacturing whole-meat, spiral-shaped jerky curls, the method as claimed in claim 1, wherein the first specified period of time is 24 hours.

11. The method of manufacturing whole-meat, spiral-shaped jerky curls, the method as claimed in claim 1, wherein the first specified temperature range is between 36 degrees Fahrenheit and 40 degrees Fahrenheit.

12. The method of manufacturing whole-meat, spiral-shaped jerky curls, the method as claimed in claim 1, wherein the second specified period of time is 6 hours.

13. The method of manufacturing whole-meat, spiral-shaped jerky curls, the method as claimed in claim 1, wherein the second specified temperature range is between 135 degrees Fahrenheit and 180 degrees Fahrenheit.

14. The method of manufacturing whole-meat, spiral-shaped jerky curls, the method as claimed in claim 12 comprises the steps of:
heating each meat strip for 30 minutes at 135 degrees Fahrenheit with the drying oven, then heating each meat strip for 30 minutes at 150 degrees Fahrenheit with the drying oven, then heating each meat strip for 30 minutes at 170 degrees Fahrenheit with the drying oven, then heating each meat strip for 15 minutes at 180 degrees Fahrenheit with the drying oven, and then dehydrating each meat strip for 4.25 hours at 160 degrees Fahrenheit with the drying oven during step (F).

15. The method of manufacturing whole-meat, spiral-shaped jerky curls, the method as claimed in claim 1, wherein the third specified period of time is 24 hours.

16. The method of manufacturing whole-meat, spiral-shaped jerky curls, the method as claimed in claim 1, wherein each perforated tube is made of electropolished stainless steel.

17. The method of manufacturing whole-meat, spiral-shaped jerky curls, the method as claimed in claim 1, wherein an outside diameter of each perforated tube is 0.629 inches, and wherein a perforation of each perforated tube is 5/32-inch hole by 3/16-inch staggered centers.

18. (canceled)

19. The method of manufacturing whole-meat, spiral-shaped jerky curls, the method as claimed in claim 1 comprises the steps of:
providing a plurality of saddles and a roll-up rack, wherein the plurality of saddles is placed on the roll-up rack;
engaging each perforated tube onto a corresponding saddle from the plurality of saddles before step (E); and,
placing the roll-up rack within the drying oven during step (E);
disengaging each perforated tube from the corresponding saddle during step (G).

20. The method of manufacturing whole-meat, spiral-shaped jerky curls, the method as claimed in claim 19, wherein the plurality of perforated tubes is spaced one inch apart by the plurality of saddles.

21. The method of manufacturing whole-meat, spiral-shaped jerky curls, the method as claimed in claim 1 comprises the steps of:
providing a plurality of bins; and,
distributing the plurality of meat strips in the spiral-shaped curls into the plurality of bins during step (H).
